(19) United States
(12) Patent Application Publication
(10) Pub. No.: US 2008/0155870 A1
(43) Pub. Date: Jul. 3, 2008

(54) Solar energy powered address identifier

(76) Inventor: Cedric Taylor, Wilmington, NC (US)

Correspondence Address: Raymond M. Galasso;Galasso & Associates LP, P.O. Box 26503, Austin, TX, 78755-0503, US

(21) Appl. No.: 11/649,078

(22) Filed: Jan. 3, 2007

(51) Int. Cl. G09F 13/04

(52) U.S. Cl. 40/564

(57) ABSTRACT

Solar Energy Powered Address Identifier is a solar powered sign equipped with a backlight and a channel or other means for insertion or display of a set of numbers representing a home or business address. To use Solar Energy Powered Address Identifier, a user chooses a location on a house or other structure that is easily viewed from the street and not obscured by any trees, shrubbery or other impediments. He then attaches the sign to the structure in the selected location. The sign typically utilizes solar power to provide power to the backlighting unit and illuminate the numbers. Sensors on the sign also permit the backlighting to intensify when car headlights or the like contact the sensors.

### CROSS REFERENCE TO RELATED APPLICATIONS

This United States Non-Provisional Patent Application does not claim priority to any United States Provisional Patent applications or any foreign patent applications.

### FIELD OF THE DISCLOSURE

The disclosures made herein relate generally to the household improvement industry. The invention discussed herein is in the general classification of home and business address signs.

### BACKGROUND

Home and business address numbers are often difficult to see in the dark. Trees, bushes and shrubs may cover home and business address numbers. Insufficient lighting around the address numbers, inadequate size of the address numbers and excessive distance of the address numbers from the street may also create viewing problems.

An individual's inability to see address numbers has many undesirable consequences. Deliveries may be delayed or terminated when a house or business number cannot be located. Friends may also become lost on the way to certain addresses. More importantly, emergency services may have difficulty locating a house or business if the address numbers cannot be clearly seen from the street.

Address numbers are often attached directly to a house or other structure or located on a curb. Weathering often deteriorates or detaches the address numbers over time. Improper lighting also prevents even address numbers in good condition from being seen.

Hence, there is a need in the art for a convenient, inexpensive and effective device for illuminating the address of a home or business.

### SUMMARY OF THE DISCLOSURE

Solar Energy Powered Address Identifier is a solar powered sign equipped with a backlight and a channel or other means for insertion or display of a set of numbers representing a home or business address.

The principal object of this invention is to provide a device that can be used to display and light the address of a home or business and that is operated by solar power.

Another object of this invention is to provide a device that can be easily installed on a home or business or placed in a yard to display the address of the home or business.

Another object of this invention is to provide an affordable device for prominently displaying an address of a home or business.

Another object of this invention is to provide a device that will permit delivery services to easily see the address of a home even in the dark.

Another object of this invention is to provide a device that will protect the address numbers from weathering.

Yet another object of the invention is to provide a device that intensifies the back lighting of an address number when light from a car or other vehicle is detected.

### BRIEF DESCRIPTION OF THE DRAWINGS

FIG. 1 depicts a perspective view of the preferred embodiment of the present invention.

FIG. 2 depicts a cross-sectional view of the preferred embodiment of the invention cut along the line A-A of FIG. 1.

### DETAILED DESCRIPTION OF THE DRAWINGS

The preferred embodiment of Solar Energy Powered Address Identifier is comprised of at least some of the following: a rectangular sign with an attaching mechanism and with a channel in a front panel for insertion of numbers, a light bulb to illuminate the numbers inserted into the channel, a solar panel to power the light bulb, a convex, transparent cover for easy viewing of the numbers and a set of light sensors operatively connected to the light bulb.

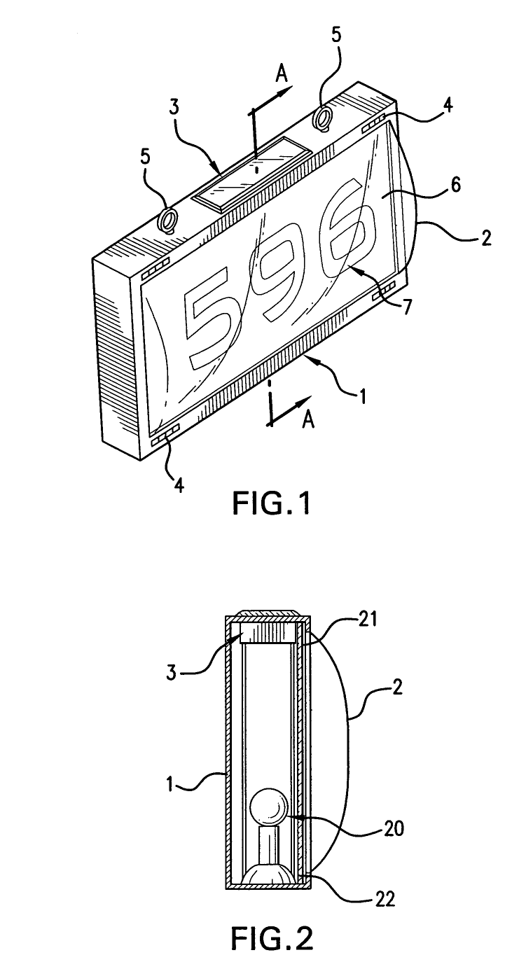

FIG. 1 shows the preferred embodiment of the present invention. A sign 1 that is rectangular has a transparent front cover 2 that is convex to more easily stand out but still permit light to easily shine through it. The sign 1 is twelve inches in length, six inches in height, and two inches in depth in this preferred embodiment. The sign 1 is made of plastic in the preferred embodiment though other materials may also be utilized. A solar panel 3 that is approximately rectangular in shape is located on top of the sign 1.

Within the sign 1, a light bulb (not pictured) is connected to the solar panel 3. Four light sensors 4 that are approximately rectangular are located on the four corners of the sign 1 to detect lights from an approaching vehicle and signal the light bulb within the sign 1 to brighten. On the top of the sign 1, an attaching mechanism of two eyelets 5 permits the sign 1 to be easily connected to a house or other structure. A plastic sheet 6 with numbers 7 can be inserted into a channel (not shown) inside the cover 2. The numbers 7 can either be made of transparent plastic or can simply be cut-outs from the plastic sheet 6 to allow light to pass through them. The area of the plastic sheet 6 surrounding the numbers 7 is opaque to prevent or minimize the passage of light.

FIG. 2 depicts a cross-sectional view of the preferred embodiment of the invention cut along the line A-A of FIG. 1. The light bulb 20 can be seen within the sign 1. The bottom of the solar panel 3 is also visible. The channel 21 for insertion of the plastic sheet can also be seen in the front of the sign 1 behind the transparent front cover 2. The channel 21 is formed between the back of the front cover 2 and a transparent layer 22 that extends the length of the rectangular sign 1. The front cover 2 and the transparent layer 22 are attached such that the entire front panel can be removed to permit insertion of the plastic sheet inside the channel 21 and changing of the light bulb 20.

A backup battery may also be located within the sign to permit the sign to operate even when the solar power is insufficient and to aid in brightening the sign when lights contact the sensors.

In another alternative embodiment of the invention, the sign could be hung from an L-shaped metal bar with hangers to display it in a yard.

To use the preferred embodiment of Solar Energy Powered Address Identifier, a user chooses a location on or near a house or other building that is easily viewed from the street and not obscured by any trees, shrubbery or other impediments. He then either uses the eyelets on the top of the sign to attach it to the structure in the selected location or hangs it from the hangers of a bar in the yard. The solar panel and/or battery provide power to the light bulb or other backlighting unit. The light transmits through the transparent layer, numbers and front cover but not through the opaque material surrounding the numbers, permitting the numbers to be seen clearly from the street. The sensors also detect light from car headlights or the like and signal to intensify the backlighting when appropriate.

The materials utilized for Solar Energy Powered Address Identifier may vary widely but will likely include metals, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Solar Energy Powered Address Identifier can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of plastics or other suitable materials and can be of any color.

Although the channel of the preferred embodiment of this invention is formed between the transparent front cover and a second transparent layer, a variety of methods may be used to sandwich the plastic sheet, including methods not requiring a transparent layer or any mechanism extending the entire length of the sign. For example, the four corners of the inside front cover of the sign may create the channel for insertion of the plastic sheet with small protuberances in each corner. A variety of other well-known methods may also be used to place the numbers within the sign without the need for a channel or a plastic sheet.

It should also be obvious that there is no limit to the number of numbers that can be included on the plastic sheet and the plastic sheet could also contain letters or other symbols. Therefore, as used herein, a set of numbers means as few as one letter, number or other symbol and can include any amount of letters, numbers or other symbols.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. An address display device comprising:
(a) a sign;
(b) a lighting unit within the sign; and
(c) a solar cell operatively connected to the lighting unit.

2. The device of claim 1 wherein the sign is rectangular.

3. The device of claim 1 wherein the sign is made of plastic.

4. The device of claim 1 wherein the sign is made of metal.

5. The device of claim 1 wherein the lighting unit is a light bulb.

6. The device of claim 1 further comprising
a set of numbers located in the sign.

7. The device of claim 1 further comprising
a transparent front cover on the sign.

8. The device of claim 7 wherein the transparent front cover is convex.

9. The device of claim 1 further comprising
an attaching mechanism on the top of the sign.

10. The device of claim 9 wherein the attaching mechanism is a set of two eyelets.

11. The device of claim 6 wherein the set of numbers are on a plastic sheet that is opaque around the set of numbers.

12. The device of claim 7 wherein a channel is located between a transparent layer and the transparent front cover.

13. The device of claim 11 wherein the set of numbers is cut out from the plastic sheet.

14. The device of claim 1 further comprising
a light sensor located on the sign and operatively attached to the lighting unit.

15. The device of claim 14 further comprising
a battery operatively attached to the lighting unit and the light sensor.

16. An address display device comprising:
(a) a sign that is rectangular and plastic having a transparent and convex front cover;
(b) a light bulb within the sign;
(c) a solar panel on top of the sign and operatively connected to the light bulb;
(d) an opaque plastic sheet with a set of transparent numbers that can be inserted between a transparent layer and the transparent and convex front cover;
(e) a set of eyelets on the top of the sign;
(f) a battery operatively connected to the light bulb; and
(g) a set of light sensors located on the sign and operatively connected to the light bulb.
